(19) United States
(12) Patent Application Publication
(10) Pub. No.: US 2013/0346245 A1
(43) Pub. Date: Dec. 26, 2013

(54) System and Method for Conducting Delegated Payments

(71) Applicant: Deepak Desore, Austin, TX (US)

(72) Inventor: Deepak Desore, Austin, TX (US)

(73) Assignee: eBay, Inc., San Jose, CA (US)

(21) Appl. No.: 13/533,609

(22) Filed: Jun. 26, 2012

(51) Int. Cl. G06Q 30/06; G06Q 20/10

(52) U.S. Cl. 705/26.41

(57) ABSTRACT

The present disclosure involves an electronic device. The electronic device includes a user interface configured to receive an input from, and display output to, a user. The electronic device includes a memory storage configured to store programming code. The electronic device includes a computer processor operatively coupled to the memory storage. The computer processor component is configured to execute the computer programming code to perform the following operations: approving a group of contacts of the user as delegated buyers; receiving, through the user interface, an alert that one of the contacts is within a predefined geographical range of a remote merchant; requesting the contact to buy merchandise from the merchant on behalf of the user; establishing a secure electronic payment channel with a mobile communications device of the contact; and transferring, via the secure electronic payment channel, funds to the contact for buying the merchandise on behalf of the user.

### BACKGROUND

1. Technical Field

The present disclosure generally relates to payments, and more particularly, to delegated payments.

2. Related Art

The recent rapid advances in computer technology and telecommunications have increased the popularity of online transactions. However, despite the ease and convenience of conducting transactions online, a consumer may still need to make purchases at a physical location of a merchant once in a while. This may be a result of several factors: the merchant may not have an online shopping site; the item(s) that the consumer wants to buy is not available online; the wait is longer for the item purchased online; the consumer does not wish to pay the shipping or delivery charge; etc. However, it may be inconvenient or time consuming for a consumer to physically visit a merchant. What is needed is a way for a consumer to make purchases at physical locations of merchants without requiring the consumer to actually visit these locations.

### SUMMARY

One of the broader forms of the present disclosure involves an electronic device. The electronic device includes: a user interface component configured to receive an input from, and display output to, a user; a computer memory storage component configured to store computer programming code; and a computer processor component operatively coupled to the computer memory storage component, wherein the computer processor component is configured to execute the computer programming code to perform the following operations: approving a group of contacts of the user as delegated buyers; receiving, through the user interface component, an alert that one of the contacts is within a predefined geographical range of a remote merchant; requesting the contact to buy merchandise from the merchant on behalf of the user; establishing a secure electronic payment channel with a mobile communications device of the contact; and transferring, via the secure electronic payment channel, funds to the contact for buying the merchandise on behalf of the user.

Another one of the broader forms of the present disclosure involves an apparatus comprising a non-transitory, tangible machine-readable storage medium storing a computer program, wherein the computer program contains machine-readable instructions that when executed electronically by processors, perform: receiving an electronic notification that a mobile communications device is in proximity of a remote merchant; sending a request to purchase a product from the merchant to the mobile communications device; receiving confirmation that the product is ready to be purchased; and sending, via a secure electronic payment channel, funds for purchasing the product to the mobile communications device.

Yet another one of the broader forms of the present disclosure involves a method of conducting an electronic transaction. The method includes: receiving an electronic notification that a mobile communications device is in proximity of a remote merchant; sending a request to purchase an item from the merchant to the mobile communications device; receiving confirmation that the item is ready to be purchased; and sending, via a secure electronic payment channel, funds for purchasing the item to the mobile communications device.

### BRIEF DESCRIPTION OF THE DRAWINGS

FIG. 1 is a simplified block diagram illustrating a context in which a delegated payment takes place according to various aspects of the present disclosure.

FIGS. 2-5 are simplified example user interfaces of a delegated payment application according to various aspects of the present disclosure

FIG. 6 is a simplified block diagram representing a series of exchanges between a user and a delegated buyer to complete a delegated transaction according to various aspects of the present disclosure.

FIG. 7 is an example method of performing a delegated transaction according to various aspects of the present disclosure.

FIG. 8 is an example computer system for implementing the various steps of the method of FIG. 7 according to various aspects of the present disclosure

FIG. 9 is a simplified example of a cloud-based computing architecture according to various aspects of the present disclosure.

FIG. 10 is a simplified block diagram a portable electronic device for implementing various methods and devices described according to various aspects of the present disclosure.

### DETAILED DESCRIPTION

It is to be understood that the following disclosure provides many different embodiments, or examples, for implementing different features of the present disclosure.

Specific examples of components and arrangements are described below to simplify the present disclosure. These are, of course, merely examples and are not intended to be limiting. Various features may be arbitrarily drawn in different scales for simplicity and clarity.

As mobile computing and communication technologies continue to advance, online transactions are becoming increasingly more prevalent. The popularity of making online transactions is partially attributed to the ease and convenience of these transactions. However, there may still be times when a consumer would prefer to make a purchase at a physical location of a merchant. Several factors may influence the consumer's decision: the merchant may not have an online shopping site; the item(s) that the consumer wants to buy is not available online; the wait is longer for the item purchased online; the consumer does not wish to pay the shipping or delivery charge; etc. However, it may be inconvenient or time consuming for a consumer to physically visit a merchant.

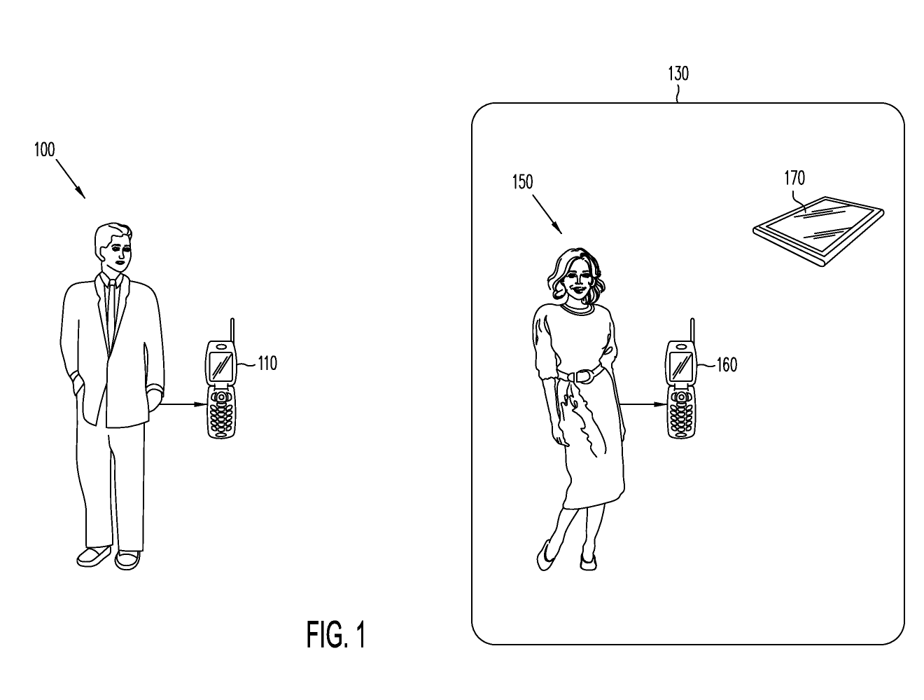

The present disclosure discloses methods and systems for conducting a delegated transaction. That is, a consumer can delegate a purchasing transaction to another person (e.g., a friend or a family relative) who is visiting a physical location of a merchant. An example context in which the delegated transaction may arise is illustrated in the block diagram of FIG. 1.

Referring to FIG. 1, a consumer (thereafter interchangeably referred to as a user) 100 has a mobile communications device 110. The mobile communications device 110 may be a portable electronic device capable of electronically processing tasks and communicating with external devices. For example, the mobile communications device 110 may include a mobile telephone (such as a smart-phone), a tablet computer, a laptop computer, or a desktop computer.

The mobile communications device 110 is configured to run a delegated payment application, which may be installed as a module on the mobile communications device 110, for example. The delegated payment application allows the user 100 to designate a list of people as trusted buyers who can be delegated with the task of making purchases on behalf of the user 100. In some cases, the list of people may be obtained from a personal contacts list on the mobile communications device 110. In other cases, the list of people may be derived from an electronic social network (for example FACEBOOK® GOOGLE+®) of the user 100. For instance, the delegated payment application may display an entire group of contacts (which may be the user's friends, family relatives, co-workers, acquaintances, etc) acquired from the user's social network to the user 100 and prompt the user 100 to select the list of people as the trusted delegated buyers.

The delegated payment application also prompts the user 100 to designate a list of merchants (for example stores, restaurants, outlets, etc) as merchants of interest. In some embodiments, the delegated payment application may automatically generate a pool of merchants from which the user 100 can designate the merchants of interest. For example, the pool of merchants may be generated by searching an electronic database such as YELP®, ZAGAT®, URBANSPOON®, or the YELLOWPAGES®. The pool of merchants may also be generated based on a geographical location of the user 100 (e.g., search for all merchants on YELP® within a ten-mile radius of the user 100). In other embodiments, the delegated payment application may allow the user 100 to directly input the name of a merchant of interest into the application.

The delegated payment application may be configured to send the user 100 notifications when one of his trusted delegated buyers is within close proximity of one of his merchants of interest. For example, the user 100 may configure the delegated payment application to send him alerts if one of his trusted delegated buyers is within a predefined distance of a particular merchant of interest (e.g., an electronics retailer). The predefined distance may be set by the user 100, which may be X feet, meters, or miles, for example.

Still referring to FIG. 1, suppose a merchant 130 has been designated by the user 100 as one of his merchants of interest, and a user 150 has been designated by the user 100 as one of his trusted delegated buyers. The user 150 also has a mobile communications device 160, which for example may be a mobile telephone (such as a smart-phone), a tablet computer, or a laptop computer. The mobile communications devices 110 and 160 each include transceivers and are configured to communicate with each other through a wired or wireless communications protocol, for example communications protocols such as IEEE 802.11 (Wi-Fi), IEEE 802.15 (Bluetooth), GSM, CDMA, LTE, WIMAX, DLNA, HDMI, etc.

When the user 150 (and the associated communications device 160) is within close proximity of the facility of the merchant 130—for example when the user 150 is physically inside the merchant's store—the locational status of the user 150 may be obtained by the delegated payment application. In some embodiments, the locational status of the user 150 may be obtained by the user 150 performing a digital “check-in” to the facility of the merchant 130. In other embodiments, the user 150 may agree to share GPS location with the user 100, so that the communications device 160 may continuously update the location of the user through GPS satellites. The communications device 110 of the user 100 receives the GPS information from the GPS satellites and as such can track the location of the user 150 constantly.

Once the delegated payment application detects that the user 150 is now within the predefined proximity of the merchant 130, the delegate payment application notifies the user 100, for example by displaying a pop-up message on the mobile communications device 110. The pop-up message may alert the user 100 that the user 150 is now capable of conducting a delegated transaction. In other words, since the user 150 is at the facility of the merchant 130, the user 150 can buy products offered by the merchant 130 on behalf of the user 100.

After receiving the notification that the user 150 is now capable of making a delegated purchase on behalf of the user 100, the user 100 may send a request (for example through the communications devices 110 and 160) to the user 150 asking the user 150 to buy one or more products from the merchant 130 on behalf of the user 100. As an example, the product may be a tablet computer 170 offered by the merchant 130. If the user 150 agrees to make the delegated purchase, a confirmation is send to the user 100 through the communication devices 160 and 110. After receiving the confirmation, the delegated payment application establishes a secure electronic payment channel with the communications device 160.

The communications devices 110 and 160 validate each other, after which the user 100 sends funds to the user 150 through the secure electronic payment channel. In some embodiments, the user 150 merely acts as a forwarding agent and forwards the funds received from the user 100 to a cashier of the merchant 130 during checkout. In other embodiments, the user 150 may pay for the product 130 with any suitable payment option, for example credit card or cash, since she has already received reimbursement for such purchase from user 100 before making the purchase. Once the delegated purchasing transaction is completed, the delegated payment application can terminate the secure electronic payment channel, or wait for the user 150 to disable the channel.

In some embodiments, the user 100 need not necessarily designate a merchant of interest ahead of making the delegated transaction. Instead, the user 100 may be able to track or monitor the movements of the user 150 (or other users who are among the trusted delegated buyers and who have agreed to share their location). As soon as the user 150 is within close proximity of a merchant such as the merchant 130, the delegated payment application may perform the steps described above to carry out the delegated transaction, even though the merchant 130 has not been designated as a merchant of interest prior to the delegated purchasing transaction.

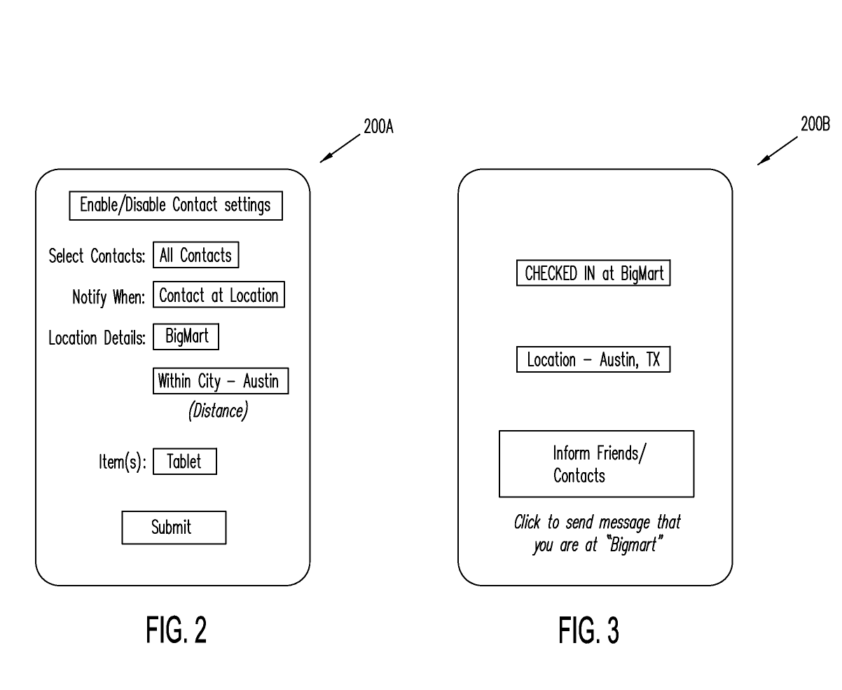

FIGS. 2-5 are example user interfaces 200 of the delegated payment application discussed above according to the various aspects of the present disclosure. The delegated payment application may be installed as a module on the mobile communications devices 110 and 160 of FIG. 1. In the following Figures, user interfaces 200A represent the delegated payment application installed on the mobile communications device 110 of the user 100 of FIG. 1, and user interfaces 200B represent the delegated payment application installed on the mobile communications device 160 of the user 150 of FIG. 1.

Referring to FIG. 2, the user interface 200A allows a user (for example the user 100 of FIG. 1) to designate one or more trusted delegated buyers by prompting the user to choose them from a list of contacts (i.e., “Select Contacts”). The user interface 200A also allows the user to designate one or more merchants of interest, which in the embodiment shown has been designated as “BigMart.” The location of the merchant of interest can also be configured, which is the city of Austin in the embodiment shown. The user interface 200A further allows the user to configure the condition under which the user receives alerts. In the embodiment shown, an alert will be sent to the user when a contact is at the location (i.e., the shopping facility of the merchant of interest). The user may optionally configure the item that he wishes to buy through the delegated user, which is a “Tablet” in the embodiment shown.

Referring to FIG. 3, one of the user's delegated buyers (for example the user 150 of FIG. 1) can notify the user that she has arrived at the merchant of interest. This notification may be done through an electronic “check-in,” as illustrated in the user interface 200B. Once the delegated buyer clicks the “Inform Friends/Contacts” button, a notification will be sent to her contacts to notify them that she is at “BigMart.”

Referring to FIG. 4, the user interface 200A displays an alert to the user that one of his delegated buyers (i.e., contact “B”) is at BigMart in the city of Austin. The user interface 200A also asks the user if he wants to delegate buying the item “Tablet” to the delegated buyer. The user may select an input YES or NO accordingly. In the illustrated embodiment, the user selects YES, which causes a request to be sent to the delegated buyer.

Referring to FIG. 5, after receiving the request that the user wishes to buy the item, the user interface 200B displays a message to the delegated buyer (e.g., the user 150 of FIG. 1), indicating that the user (i.e., contact “A”) is wishing to buy the item “Tablet” from BigMart, and whether she is willing to help. The delegated buyer may select an input YES or NO accordingly. In the illustrated embodiment, the delegated buyer selects YES, which sends a confirmation to the user that the item “Tablet” is ready (or soon will be) for purchase.

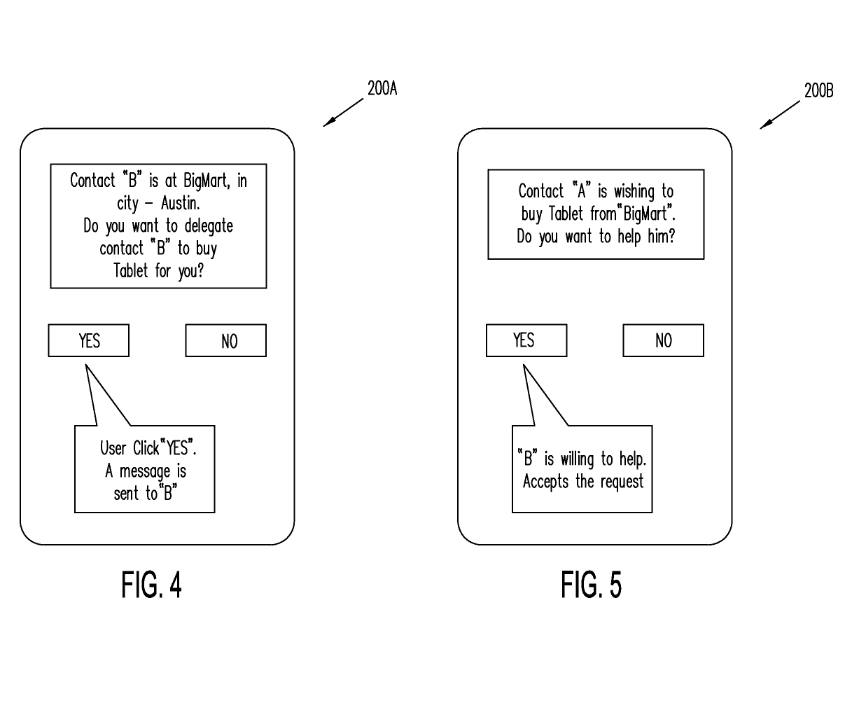

FIG. 6 illustrates a block diagram representing a series of exchanges between the user (denoted by user A herein) and the delegated buyer (denoted by user B herein) to complete the delegated transaction. These exchanges may take place on the mobile communications devices associated with the user and the delegated buyer (for example, the mobile communications devices 110 and 160 of FIG. 1). In various embodiments, these exchanges are made between the delegated payment modules installed on the respective mobile communications devices.

First, a secure electronic payment channel 250 is established between the two mobile communications devices 110 and 160. A request to buy the Tablet is then sent to user B via the secure electronic payment channel 250. In response to the request, a request to authenticate a withdrawal of a certain amount (e.g., $500) of funds is sent to user A. The amount of funds corresponds to the price of the item (Tablet) to be bought. Thereafter, the request for withdrawing the funds is authenticated, and permission is given to user B to purchase the item and to withdraw the funds from user A's account to cover the purchase. If and when the user B requests the actual withdrawal of the funds, user A will send the funds to user B over the secure electronic payment channel 250.

In some embodiments, user B acts as a forwarding agent. That is, the payment from user A is sent directly to the cashier at the checkout of the merchant without going into the user B's account. In other embodiments, the payment from user A is deposited into user B's account, and user B may then choose a method of paying for the item at the checkout of the merchant in any manner he wishes, for example by paying with cash or a credit card. In other words, user B is reimbursed before or during making the delegated purchase. In any case, after the checkout is completed, a receipt for the purchase is sent via the secure electronic payment channel 250 to the user A, for example to a registered email of user A. Thereafter, the secure electronic payment channel 250 is terminated.

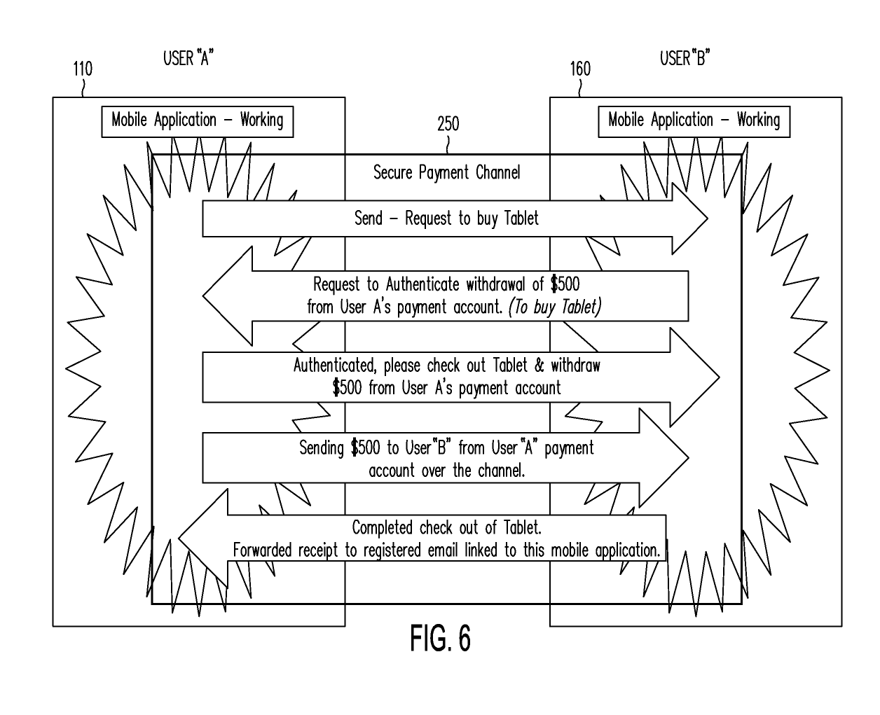

FIG. 7 is a flowchart of a method 400 of performing the various tasks of the delegated payment application discussed above. The method 400 includes a step 410, in which a list of trusted delegated purchasers is designated, and a list of merchants of interest is also designated. The designation of the trusted delegated purchasers and the merchants of interest are done in response to an input from a user. In some embodiments, the list of trusted delegated purchasers is derived from a group of contacts, which may be generated based on an electronic social network of the user. In some embodiments, the designations of the step 410 may be performed so that the trusted delegated purchasers are all located within a predefined geographical range.

The method 400 includes a step 420, in which an electronic notification is received. The electronic notification notifies the user that a first mobile communications device is in proximity of a merchant. The first mobile communications device is associated with one of the trusted delegated purchasers designated by the user. The merchant is one of the merchants of interest designated by the user. In some embodiments, the electronic notification is received by a second mobile communications device associated with the user. The first and second mobile communications devices are configured to communicate with each other through a wired or wireless communications protocol.

The method 400 includes a step 430, in which a request to purchase an item from the merchant is sent to the first mobile communications device. The request is sent by the second communications device in response to an input from the user. The method 400 includes a step 440, in which a confirmation is received that indicates the item is ready to be purchased. The method 400 includes a step 450, in which a secure electronic payment channel is established. The secure electronic payment channel is established between the first and second communications devices. The method 400 includes a step 460, in which funds for purchasing the item is sent to the first mobile communications device via the secure electronic payment channel. The method 400 includes a step 470, in which the secure electronic payment channel is terminated after the funds are sent. In some embodiments, the steps 410-470 are performed at least in part by a delegated payment module that resides on the second mobile communications device

It is understood that additional method steps may be performed before, during, or after the steps 410-470 discussed above. For the sake of simplicity, however, these additional steps are not specifically illustrated or discussed herein.

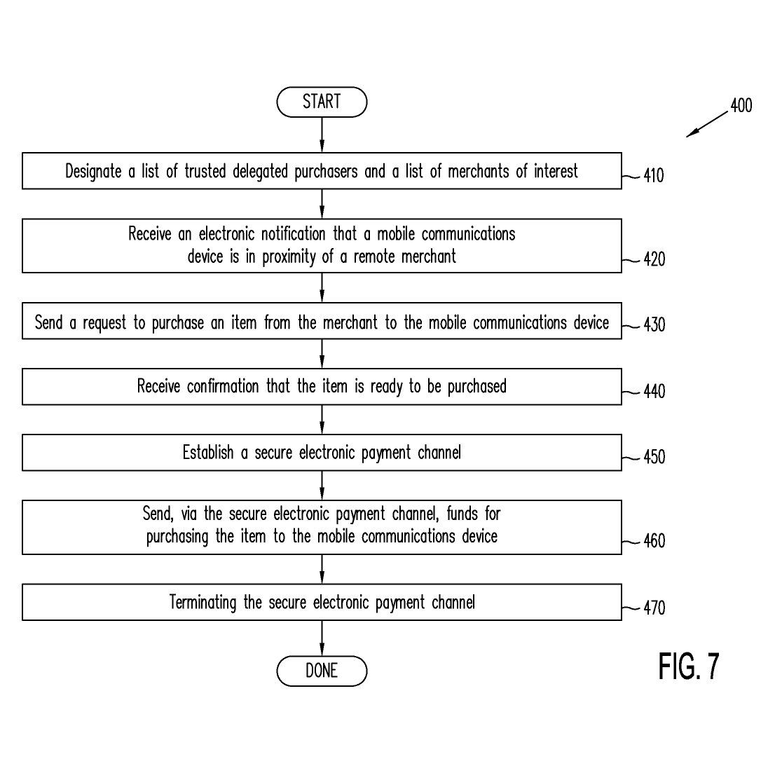

FIG. 8 is a block diagram of a computer system 600 suitable for implementing various methods and devices described herein, for example, the various method steps of the method 400. In various implementations, the devices capable of performing the steps may comprise a network communications device (e.g., mobile cellular phone, laptop, personal computer, tablet, etc.), a network computing device (e.g., a network server, a computer processor, an electronic communications interface, etc), or another suitable device. Accordingly, it should be appreciated that the devices capable of implementing the method 400 may be implemented as the computer system 600 in a manner as follows.

In accordance with various embodiments of the present disclosure, the computer system 600, such as a network server or a mobile communications device, includes a bus component 602 or other communication mechanisms for communicating information, which interconnects subsystems and components, such as a computer processing component 604 (e.g., processor, micro-controller, digital signal processor (DSP), etc.), system memory component 606 (e.g., RAM), static storage component 608 (e.g., ROM), disk drive component 610 (e.g., magnetic or optical), network interface component 612 (e.g., modem or Ethernet card), display component 614 (e.g., cathode ray tube (CRT) or liquid crystal display (LCD)), input component 616 (e.g., keyboard), cursor control component 618 (e.g., mouse or trackball), and image capture component 620 (e.g., analog or digital camera). In one implementation, disk drive component 610 may comprise a database having one or more disk drive components.

In accordance with embodiments of the present disclosure, computer system 600 performs specific operations by the processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of (or in combination with) software instructions to implement the present disclosure.

Logic may be encoded in a computer readable medium, which may refer to any medium that participates in providing instructions to the processor 604 for execution. Such a medium may take many forms, including but not limited to, non-volatile media and volatile media. In one embodiment, the computer readable medium is non-transitory. In various implementations, non-volatile media includes optical or magnetic disks, such as disk drive component 610, and volatile media includes dynamic memory, such as system memory component 606. In one aspect, data and information related to execution instructions may be transmitted to computer system 600 via a transmission media, such as in the form of acoustic or light waves, including those generated during radio wave and infrared data communications. In various implementations, transmission media may include coaxial cables, copper wire, and fiber optics, including wires that comprise bus 602.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 630 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 600 may transmit and receive messages, data, information and instructions, including one or more programs (i.e., application code) through communication link 630 and communication interface 612. Received program code may be executed by computer processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

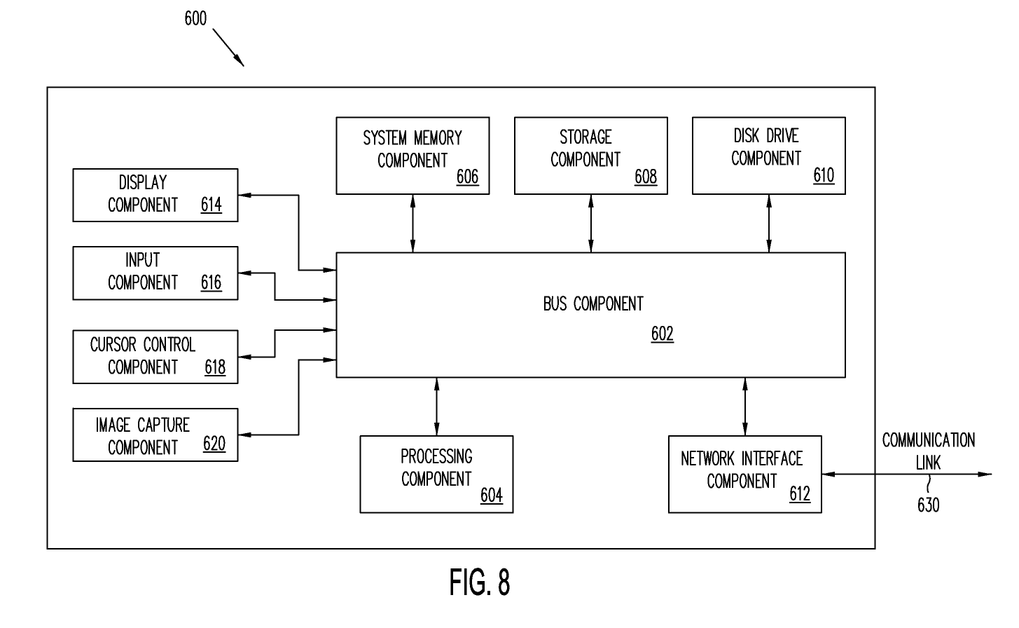

FIG. 9 illustrates an example cloud-based computing architecture 700, which may also be used to implement various aspects of the present disclosure. The cloud-based computing architecture 700 includes a mobile device 704 and a computer 702, both connected to a computer network 706 (e.g., the Internet or an intranet). In one example, a consumer has the mobile device 704, which is configured to run software to provide an app with the functionality described above with respect to FIGS. 1-6.

The mobile device 704 is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing and caching may be performed by the cloud-based resources 708. However, other divisions of responsibility are also possible in various embodiments.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702.

It is understood that the various components of cloud-based computing architecture 700 are shown as examples only. For instance, a given user may access the cloud-based resources 708 by a number of devices, not all of the devices being mobile devices. Similarly, a merchant or another user may access resources 708 from any number of suitable mobile or non-mobile devices. Furthermore, the cloud-based resources 708 may accommodate many merchants and users in various embodiments.

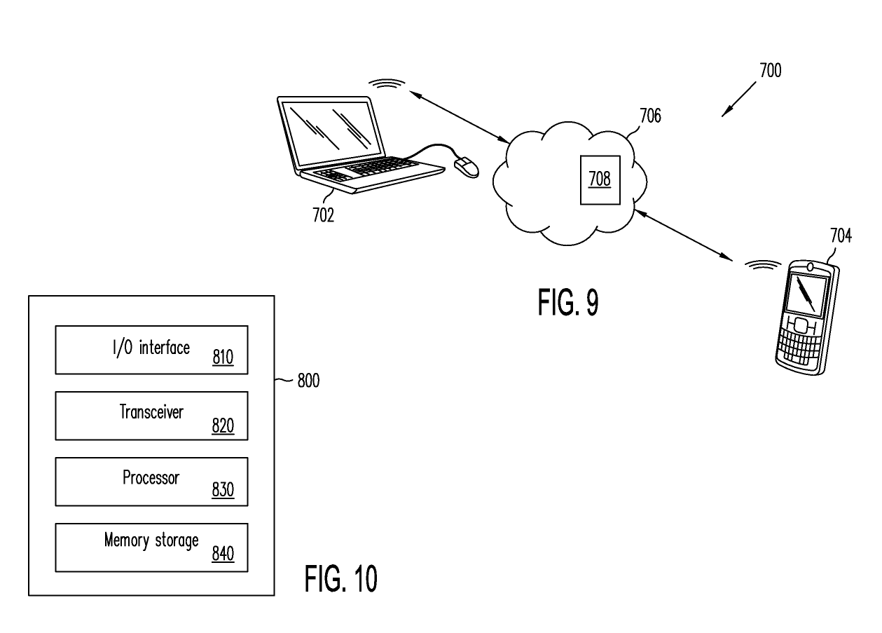

FIG. 10 is a simplified block diagram of an example electronic device 800 on which an application (e.g., the delegated payment application) may be implemented according to various aspects of the present disclosure. The electronic device 800 may be a portable personal electronic device, such as a smart phone, laptop, or a tablet.

The electronic device 800 includes an input/output interface 810. The interface 810 is operable to receive an input from a user and communicate an output to the user. The user may include a consumer or a merchant. In an embodiment, the input/output interface 810 includes a visual display unit, for example a touch-sensitive screen. The input/output interface 810 may also include physical and/or virtual buttons (such as power and volume buttons) on or off the touch-sensitive screen, physical and/or virtual keyboards, mouse, track balls, speakers, microphones, light-sensors, light-emitting diodes (LEDs), communications ports (such as USB or HDMI ports), joy-sticks, image-capture devices (for example cameras), etc. The input/output interface 810 may be used display a graphical user interface, such the interfaces 200A-B of FIGS. 2-5.

The electronic device 800 includes a transceiver 820. The transceiver 820 contains various electronic circuitry components configured to conduct telecommunications with one or more external devices. The electronic circuitry components allow the transceiver 820 to conduct telecommunications in one or more of the wired or wireless telecommunications protocols, including communications protocols such as IEEE 802.11 (WiFi), IEEE 802.15

(Bluetooth), GSM, CDMA, LTE, WIMAX, DLNA, HDMI, etc. In some embodiments, the transceiver 820 includes antennas, filters, low-noise amplifiers, digital-to-analog (DAC) converters, analog-to-digital (ADC) converters, and transceivers. The transceiver 820 may further include circuitry components such as mixers, amplifiers, oscillators, phase-locked loops (PLLs), and/or filters. Some of these electronic circuitry components may be integrated into a single discrete device or an integrated circuit (IC) chip.

The electronic device 800 also includes a computer processor 830 that is operable to execute computer instructions. The computer processor 830 may contain one or more central processing units (CPUs), graphics processing units (GPUs), or digital signal processors (DSPs), which may each be implemented using various digital circuit blocks (including logic gates such as AND, OR, NAND, NOR, XOR gates, etc) along with certain software code.

The electronic device 800 includes a memory storage 840. The memory storage 840 may contain various forms of digital memory, such as hard disks, FLASH, SRAM, DRAM, ROM, EPROM, memory chips or cartridges, etc. Computer programming code may be permanently or temporarily stored in the memory storage 840, for example. The processor 830 may be used to execute the computer programming code stored in the memory storage 840.

The memory storage 840 also contains a program module that is an embodiment of the delegated payment application that interacts with the consumer and the delegated buyer. The program module operates to provide actions, such as sending/receiving alerts, prompting the user for responses, facilitating item identification, establishing payment channels, providing payment, and/or the like.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1-6. (canceled)

7. An apparatus comprising a non-transitory computer readable medium comprising executable instructions that when executed by a processor, causes the processor to perform the steps of:
receiving, by a second mobile communications device of a buyer, an electronic notification that a first mobile communications device of a delegated purchaser is in proximity of a remote merchant that is remotely located from the buyer;
sending, by the second mobile communications device to the first mobile communications device, a request to purchase on behalf of the buyer a product from the merchant;
receiving, by the second mobile communications device, confirmation from the first mobile communications device that the product is ready to be purchased; and
sending, by the second mobile communications device via a secure electronic payment channel, funds for purchasing the product to the first mobile communications device;
wherein the processor that executes the steps of the receiving the electronic notification, the sending the request, the receiving the confirmation, and the sending the funds is a processor of a second mobile communications device of the buyer.

8. The apparatus of claim 7, wherein the second mobile communications device includes a transceiver configured to communicate with the first mobile communications device through a wireless communications protocol.

9. The apparatus of claim 8, wherein the executable instructions are stored at least in part by in a delegated payment module that resides on an electronic memory component of the second mobile communications device.

10. The apparatus of claim 7, wherein the executable instructions, when executed by a processor, causes the processor to further perform a step of: designating a list of people as qualified delegated purchasers before the receiving the electronic notification is performed, wherein the first mobile communications devices is associated with one of the qualified delegated purchasers.

11. The apparatus of claim 10, wherein the executable instructions, when executed by a processor, causes the processor to further perform a step of: generating the list of people based on an electronic social network.

12. The apparatus of claim 10, wherein the step of the designating is performed to ensure that the qualified delegated purchasers are all located within a predefined geographical range.

13. The apparatus of claim 7, wherein the executable instructions, when executed by a processor, causes the processor to further perform a step of: designating a list of merchants as merchants of interest before the receiving the electronic notification is performed, wherein the remote merchant is one of the merchants of interest.

14. The apparatus of claim 7, wherein the executable instructions, when executed by a processor, causes the processor to further perform the steps of:
establishing the secure electronic payment channel before the sending the funds; and
terminating the secure electronic payment channel after the sending the funds.

15. A method of conducting an electronic transaction, comprising:
receiving, by a second mobile communications device of a buyer, an electronic notification that a first mobile communications device of a delegated purchaser is in proximity of a remote merchant that is remotely located from the buyer;
sending, by the second mobile communications device to the first mobile communications device, a request to purchase on behalf of the buyer a product from the merchant to the first mobile communications device;
receiving, by the second mobile communications device, confirmation from the first mobile communications device that the product is ready to be purchased; and
sending, by the second mobile communications device via a secure electronic payment channel, funds for purchasing the product to the first mobile communications device;
wherein the receiving the electronic notification, the sending the request, the receiving the confirmation, and the sending the funds are each performed by one or more electronic processors of a second mobile communications device of the buyer.

16. The method of claim 15, wherein the second mobile communications device is communicatively coupled to the first mobile communications device through a wireless communications protocol.

17. The method of claim 16, wherein the receiving the electronic notification, the sending the request, the receiving the confirmation, and the sending the funds are performed at least in part by a delegated payment module that resides on the second mobile communications device.

18. The method of claim 15, further comprising: designating a list of trusted delegated purchasers before the receiving the electronic notification is performed, wherein the first mobile communications device is associated with one of the trusted delegated purchasers.

19. The method of claim 18, further comprising: generating a group of contacts based on an electronic social network, wherein the list of trusted delegated purchasers is derived from the group of contacts.

20. The method of claim 18, wherein the designating is performed so that the trusted delegated purchasers are all located within a predefined geographical range.

21. The method of claim 15, further comprising: designating a list of merchants of interest before the receiving the electronic notification is performed, wherein the remote merchant is one of the merchants of interest.

22. The method of claim 15, further comprising:
establishing the secure electronic payment channel before the sending the funds; and
terminating the secure electronic payment channel after the sending the funds.

23. An electronic device, comprising:
a user interface component configured to receive an input from, and display output to, a user;
a non-transitory computer readable medium comprising executable instructions; and
a computer processor communicatively coupled to the non-transitory computer readable medium, wherein the computer processor executes the executable instructions to perform the steps of:
receiving an electronic notification that a mobile communications device is in proximity of a remote merchant that is remotely located from the buyer, wherein the mobile communications device is a portable electronic device of a delegated purchaser;
sending, in response to input from a buyer, a request to the mobile communications device asking the delegated purchaser to purchase an item from the merchant on behalf of the buyer;
receiving confirmation from the mobile communications device that the item is ready to be purchased by the delegated purchaser;
establishing a secure electronic payment channel with the mobile communications device;
sending, via the secure electronic payment channel, funds for purchasing the item to the delegated purchaser via the mobile communications device; and
thereafter terminating the secure electronic payment channel.

24. The electronic device of claim 23, wherein the electronic device is a portable electronic device of the buyer and is configured to communicate with the mobile communications device of the delegated purchaser through a wireless communications protocol.

25. The electronic device of claim 23, wherein the mobile communications device of the delegated purchaser is associated with a group of contacts obtained from an electronic social network of the buyer.

26. The electronic device of claim 23, wherein the executable instructions, when executed, further perform a step of:
designating a list of merchants as merchants of interest before the electronic notification is received, wherein the remote merchant is one of the merchants of interest.

27. (canceled)

28. The electronic device of claim 23, wherein the user interface includes a touch-screen display, and wherein the executable instructions are executed so that the electronic notification is received as a pop-up message on the touch-screen display.

29. The electronic device of claim 23, wherein the executable instructions, when executed, further perform a step of:
designating a group of people as qualified delegated purchasers before the receiving of the electronic notification, wherein the delegated purchaser is a member of the group of people who have been designated as qualified delegated purchasers.
